(19) United States
(12) Patent Application Publication
(10) Pub. No.: US 2012/0054683 A1
(43) Pub. Date: Mar. 1, 2012

(54) METHOD, APPARATUS, COMPUTER PROGRAM AND USER INTERFACE

(75) Inventors: KORT SANDS, London (GB); Felice Mancino, Helsinki (FI); Alex Nakonechnyj, London (GB); Andrew Gray, Epsom (GB); Andrew Lin, New York, NY (US); Andrew Borovsky, New York, NY (US); Jerry Knight, New York, NY (US)

(73) Assignee: Nokia Corporation

(21) Appl. No.: 12/873,656

(22) Filed: Sep. 1, 2010

(51) Int. Cl. G06F 3/048

(52) U.S. Cl. 715/825; 715/810

(57) ABSTRACT

A method, apparatus, computer program and user interface wherein the method comprises: displaying on a display of an apparatus a plurality of items comprising a first subset of items and a second subset of items wherein the first subset of the plurality of items comprise notifications of events associated with the apparatus and the second subset of the plurality items comprise notifications of events occurring at one or more external servers.

### TECHNOLOGICAL FIELD

Embodiments of the present invention relate to a method, apparatus, computer program and user interface. In particular, they relate to a method, apparatus, computer program and user interface which enable a user to view notifications relating to events.

### BACKGROUND

Apparatus which enable users to view notifications relating to external events are known. For example a communication apparatus may enable a user to access the internet and obtain information from one or more remote servers. The information may relate to events such as news feeds or updates to networking services.

The user of the apparatus may also view notifications relating to events associated with the apparatus. For example, the user may view events which relate to incoming communications such as messages or telephone calls.

It may be useful to provide the notifications to a user in a manner which is easily accessible and which is intuitive for a user to use.

### BRIEF SUMMARY

According to various, but not necessarily all, embodiments of the invention there is provided a method comprising: displaying on a display of an apparatus a plurality of items comprising a first subset of items and a second subset of items wherein the first subset of the plurality of items comprise notifications of events associated with the apparatus and the second subset of the plurality items comprise notifications of events occurring at one or more external servers.

In some embodiments of the invention the method may further comprise updating the first subset of the plurality of items in response to a user input. Updating the first subset of the plurality of items may comprise adding an item to the first subset of the plurality of items. Updating the first subset of the plurality of items may comprise removing an item from the first subset of the plurality of items. The user input may also enable the apparatus to perform a function using an application associated with the item which is removed from the first subset of the plurality of items.

In some embodiments of the invention the events associated with the apparatus may comprise events which occur within the apparatus.

In some embodiments of the invention the first subset of the plurality of items may comprise one or more notifications of events which use a first application of the apparatus and one or more notifications of events which use a second application of the apparatus. The first application may comprise a calendar function and the second application may comprise a communication function.

In some embodiments of the invention the plurality of items may be displayed on a default graphical user interface.

In some embodiments of the invention the method may also comprise detecting a user input selecting an item and, in response to the detection of the user input, enabling access to an application associated with the selected item.

In some embodiments of the invention the method may also comprise automatically updating the items in the second subset of the plurality items.

In some embodiments of the invention the second subset of the plurality items may comprise notifications about events associated with a service which the user has subscribed to.

According to various, but not necessarily all, embodiments of the invention there is provided an apparatus comprising: at least one processor; and at least one memory including computer program code; wherein the at least one memory and the computer program code are configured to, with the at least one processor, enable the apparatus to: display, on a display, a plurality of items comprising a first subset of items and a second subset of items wherein the first subset of the plurality of items comprise notifications of events associated with the apparatus and the second subset of the plurality items comprise notifications of events occurring at one or more external servers.

In some embodiments of the invention the at least one memory and the computer program code may also be configured to, with the at least one processor, enable the apparatus to update the first subset of the plurality of items in response to a user input. Updating the first subset of the plurality of items may comprise adding an item to the first subset of the plurality of items. Updating the first subset of the plurality of items comprises removing an item from the first subset of the plurality of items. In response to the user input the at least one memory and the computer program code may be configured to, with the at least one processor, enable the apparatus to perform a function using an application associated with the item which is removed from the first subset of the plurality of items.

In some embodiments of the invention the events associated with the apparatus may comprise events which occur within the apparatus.

In some embodiments of the invention the first subset of the plurality of items may comprise one or more notifications of events which use a first application of the apparatus and one or more notifications of events which use a second application of the apparatus. The first application may comprise a calendar function and the second application may comprise a communication function.

In some embodiments of the invention the plurality of items are displayed on a default graphical user interface.

In some embodiments of the invention the at least one memory and the computer program code are configured to, with the at least one processor, may enable the apparatus to perform detecting a user input selecting an item and, in response to the detection of the user input, enabling access to an application associated with the selected item.

In some embodiments of the invention the at least one memory and the computer program code are configured to, with the at least one processor, may enable the apparatus to perform automatically updating the items in the second subset of the plurality items.

In some embodiments of the invention the second subset of the plurality items may comprise notifications about events associated with a service which the user has subscribed to.

According to various, but not necessarily all, embodiments of the invention there is provided a computer program comprising computer program instructions that, when executed by at least one processor, enable an apparatus at least to perform: displaying on a display a plurality of items comprising a first subset of items and a second subset of items wherein the first subset of the plurality of items comprise notifications of events associated with the apparatus and the second subset of the plurality items comprise notifications of events occurring at one or more external servers.

In some embodiments of the invention the computer program may comprise program instructions for causing a computer to perform the any of the methods described above.

In some embodiments of the invention there may be provided a physical entity embodying the computer program as described above.

In some embodiments of the invention there may be provided an electromagnetic carrier signal carrying the computer program as described above.

According to various, but not necessarily all, embodiments of the invention there is provided a user interface comprising: a display configured to display a plurality of items comprising a first subset of items and a second subset of items wherein the first subset of the plurality of items comprise notifications of events associated with the apparatus and the second subset of the plurality items comprise notifications of events occurring at one or more external servers.

In some embodiments of the invention the user interface may further comprise a user input device, wherein the first subset of the plurality of items are updated in response to detection of a user input.

According to various, but not necessarily all, embodiments of the invention there is provided an apparatus comprising: means for displaying a plurality of items comprising a first subset of items and a second subset of items wherein the first subset of the plurality of items comprise notifications of events associated with the apparatus and the second subset of the plurality items comprise notifications of events occurring at one or more external servers.

According to various, but not necessarily all, embodiments of the invention there is provided a method comprising: displaying, on a display of an apparatus, a notification of an event associated with the apparatus; and detecting a user input wherein; in response to detection of a first type of user input the notification is added to a list of notifications and in response to detection of a second type of user input the notification is removed from the display and is not added to the list of notifications.

In some embodiments of the invention the method may further comprise, displaying one or more user selectable items in relation to the notification. The first type of user input may comprise selection of a user selectable item.

In some embodiments of the invention the method may further comprise, in response to the detection of a user input, displaying information relating to the notification.

In some embodiments of the invention, in response to a third type of user input, an application associated with the notification may be accessed to enable the apparatus to perform a function in relation to the notification.

In some embodiments of the invention the second type of user input may comprise a flick input.

In some embodiments of the invention the list of notifications may be displayed on a default graphical user interface.

In some embodiments of the invention the list of notifications may comprise a plurality of items and the notification may be added to a first subset of the plurality of items where the first subset of the plurality of items may comprise notifications of events associated with the apparatus.

In some embodiments of the invention the list of notifications may comprise a second subset of the plurality of items and the second subset of the plurality items may comprise notifications of events occurring at one or more external servers.

According to various, but not necessarily all, embodiments of the invention there is provided an apparatus comprising: at least one processor; and at least one memory including computer program code; wherein the at least one memory and the computer program code are configured to, with the at least one processor, enable the apparatus to: display, on a display, a notification of an event associated with the apparatus; detect a user input; in response to detection of a first type of user input add the notification to a list of notifications; and in response to detection of a second type of user input remove the notification from the display wherein in response to detection of a second type of user input the notification is not added to the list of notifications.

In some embodiments of the invention the at least one memory and the computer program code may be configured to, with the at least one processor, also enable the apparatus to, display one or more user selectable items in relation to the notification.

In some embodiments of the invention the first type of user input may comprise selection of a user selectable item.

In some embodiments of the invention the at least one memory and the computer program code may be configured to, with the at least one processor, also enable the apparatus to display, in response to the detection of a user input, information relating to the notification.

In some embodiments of the invention in response to a third type of user input an application associated with the notification may be accessed to enable the apparatus to perform a function in relation to the notification.

In some embodiments of the invention the second type of user input may comprise a flick input.

In some embodiments of the invention the list of notifications may be displayed on a default graphical user interface.

In some embodiments of the invention the list of notifications may comprise a plurality of items and the notification is added to a first subset of the plurality of items where the first subset of the plurality of items comprise notifications of events associated with the apparatus.

In some embodiments of the invention the list of notifications may comprise a second subset of the plurality of items and the second subset of the plurality items may comprise notifications of events occurring at one or more external servers.

According to various, but not necessarily all, embodiments of the invention there is provided a computer program comprising computer program instructions that, when executed by at least one processor, enable an apparatus at least to perform: displaying, on a display, a notification of an event associated with the apparatus; and detecting a user input wherein; in response to detection of a first type of user input the notification is added to a list of notifications and in response to detection of a second type of user input the notification is removed from the display and is not added to the list of notifications.

In some embodiments of the invention the computer program may comprise program instructions for causing a computer to perform the any of the methods described above.

In some embodiments of the invention there may be provided a physical entity embodying the computer program as described above.

In some embodiments of the invention there may be provided an electromagnetic carrier signal carrying the computer program as described above.

According to various, but not necessarily all, embodiments of the invention there is provided a user interface comprising: a display configured to display a notification of an event associated with an apparatus; and a user input device wherein; in response to detection of a first type of user input the notification is added to a list of notifications and in response to detection of a second type of user input the notification is removed from the display and is not added to the list of notifications.

In some embodiments of the invention the display may be configured to display one or more user selectable items in relation to the notification.

According to various, but not necessarily all, embodiments of the invention there is provided an apparatus comprising: means for displaying, a notification of an event associated with the apparatus; and means for detecting a user input wherein; in response to detection of a first type of user input the notification is added to a list of notifications and in response to detection of a second type of user input the notification is removed from the display and is not added to the list of notifications.

The apparatus may be for wireless communication.

### BRIEF DESCRIPTION

For a better understanding of various examples of embodiments of the present invention reference will now be made by way of example only to the accompanying drawings in which: For a better understanding of various examples of embodiments of the present invention reference will now be made by way of example only to the accompanying drawings in which:

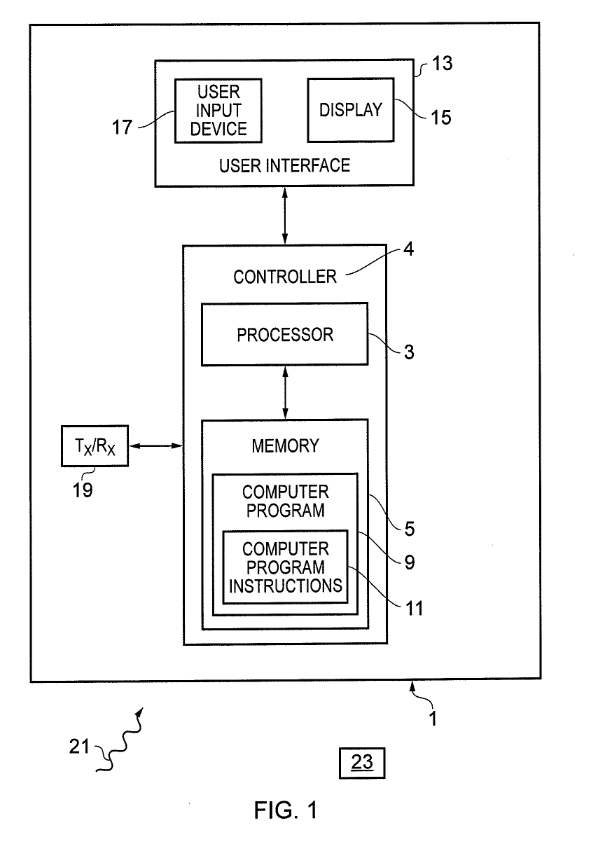

FIG. 1 schematically illustrates an apparatus according to an exemplary embodiment of the invention;

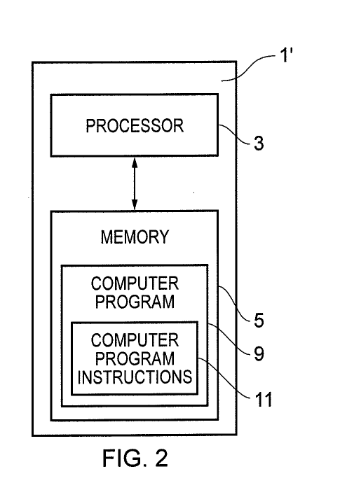

FIG. 2 schematically illustrates an apparatus according to another exemplary embodiment of the invention;

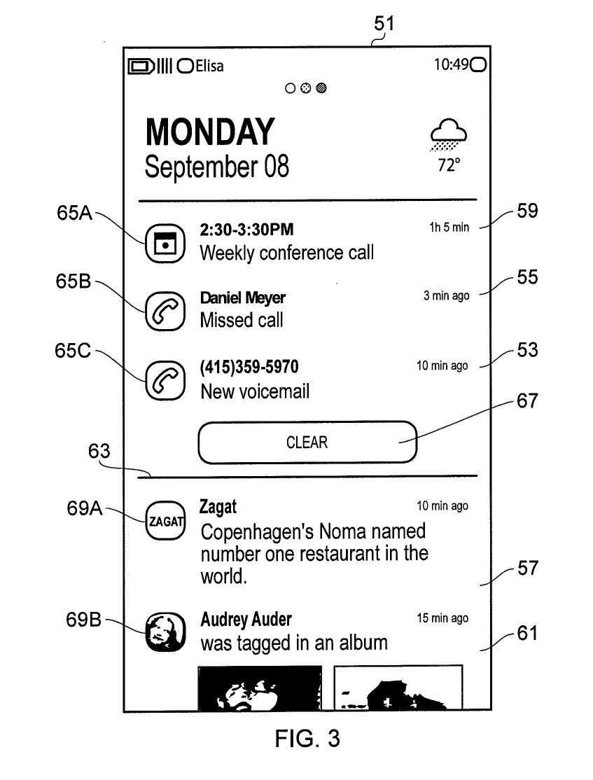

FIG. 3 illustrates a graphical user interfaces according to an exemplary embodiment of the invention;

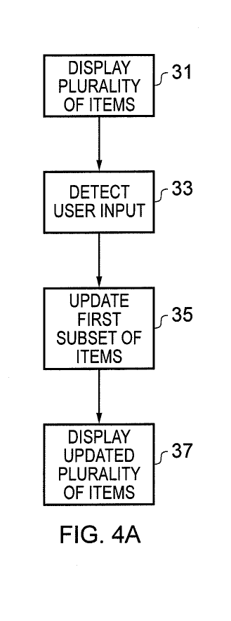

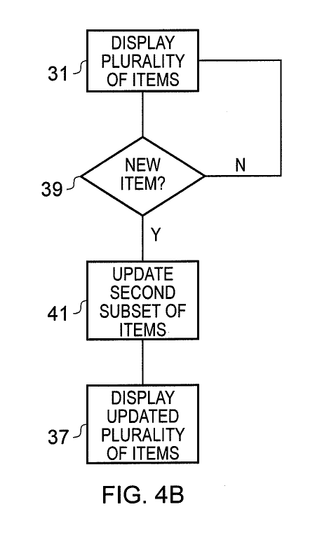

FIGS. 4A and 4B are block diagrams which schematically illustrate a method according to an exemplary embodiment of the invention;

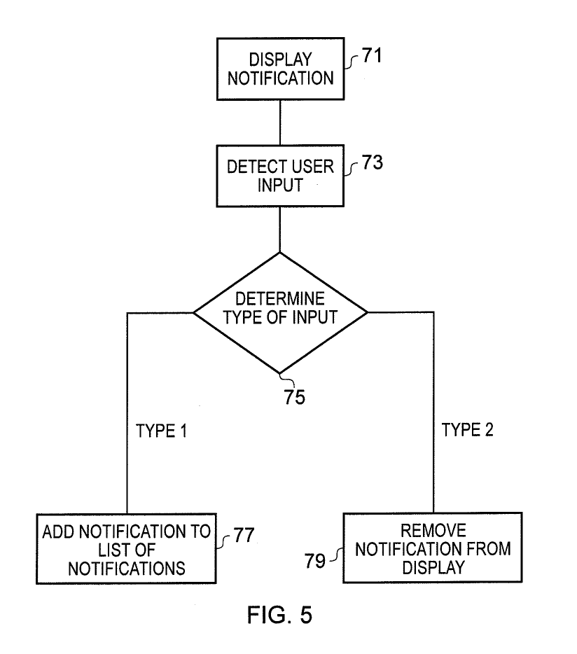

FIG. 5 is a block diagram which schematically illustrates a method according to an exemplary embodiment of the invention; and

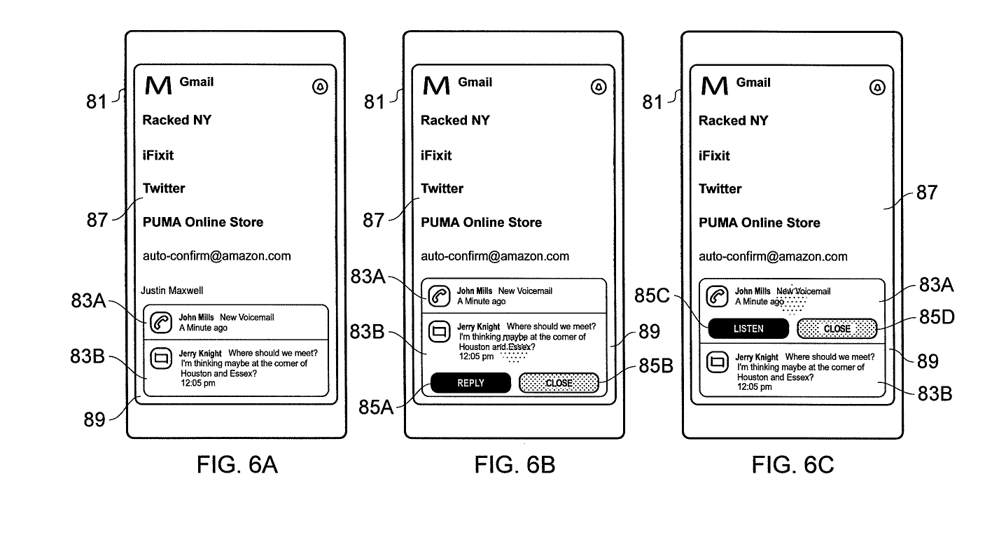

FIGS. 6A to 6C illustrate graphical user interfaces according to another exemplary embodiment of the invention.

### DETAILED DESCRIPTION

The Figures illustrate a method comprising: displaying on a display 15 of an apparatus 1 a plurality of items 53 comprising a first subset of items 55 and a second subset of items 57 wherein the first subset of the plurality of items 55 comprise notifications of events associated with the apparatus 1 and the second subset of the plurality items 57 comprise notifications of events occurring at one or more external servers.

The Figures also illustrate a method comprising: displaying, on a display 15 of an apparatus 1, a notification 83 of an event associated with the apparatus 1; and detecting 73 a user input wherein; in response to detection of a first type of user input the notification 83 is added 77 to a list of notifications and in response to detection of a second type of user input the notification 83 is removed 79 from the display 15 and is not added to the list of notifications.

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a gaming device, a personal digital assistant, a personal music player or any other apparatus which enables a user to make user inputs to control the apparatus 1. The apparatus 1 may be a handheld apparatus 1 which can be carried in a user's hand, handbag or jacket pocket for example.

Only features referred to in the following description are illustrated in FIG. 1. However, it should be understood that the apparatus 1 may comprise additional features that are not illustrated.

The apparatus 1 illustrated in FIG. 1 comprises: a user interface 13, a controller 4 and a transceiver 19. In the illustrated embodiment the controller 4 comprises at least one processor 3 and at least one memory 5 and the user interface 13 comprises a display 15 and a user input device 17. In the illustrated embodiment the transceiver 19 is shown as a single entity. It would be appreciated by a person skilled in the art that the transceiver 19 may comprise one or more separate receivers and transmitters.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and to send and receive messages such as SMS (short message service) messages or MMS (multimedia message service) messages. The apparatus 1 may also be configured to perform other functions such as access communication networks such as local area networks or the internet. In some embodiments of the invention the controller 4 may also be configured to enable a user to enter and store information in the one or more memories 5. The information may be stored, for example, in a calendar or diary application.

The controller 4 may also be configured to enable the apparatus 1 to display on a display 15 of the apparatus 1 a plurality of items 53 comprising a first subset of items 55 and a second subset of items 57 wherein the first subset of the plurality of items 55 comprise notifications of events associated with the apparatus 1 and the second subset of the plurality items 57 comprise notifications of events occurring at one or more external servers.

The controller 4 may also be configured to enable the apparatus 1 to display 71, on a display 15, a notification 83 of an event associated with the apparatus 1; detect 73 a user input; in response to detection of a first type of user input add 77 the notification to a list of notifications; and in response to detection of a second type of user input remove 79 the notification from the display 15 wherein in response to detection of a second type of user input the notification is not added to the list of notifications.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The user input device 17 provides means for enabling a user of the apparatus 1 to input information which may be used to control the apparatus 1. The user input device 17 may also enable a user to input information which may be stored in the one or more memories 5 of the apparatus 1. The user input device 17 may comprise any means which enables a user to input information into the apparatus 1. For example the user input device 17 may comprise a keypad or a portion of a touch sensitive display or a combination of a number of different types of user input devices.

The display 15 may comprise any means which enables information to be displayed to a user of the apparatus 1. The information which is displayed may comprise notifications of events which are associated with the apparatus 1 or events which occur at one or more external servers. The information which is displayed may correspond to information which has been input by the user via the user input device 17, information which is stored in the one or more memories 5 or information which has been received by apparatus 1.

The display 15 may be configured to display graphical user interfaces 51, 81 as illustrated in FIGS. 3 and 6A to 6C.

The apparatus 1 illustrated in FIG. 1 also comprises a transceiver 19. The transceiver 19 may comprise any means which enables the apparatus 1 transmit and receive information. The transceiver 19 may enable the apparatus 1 to communicate directly with one or more other apparatus. For example, the transceiver 19 may enable the apparatus 1 to communicate with one or more external servers or with one or more other hand held apparatus.

In some embodiments of the invention the transceiver 19 may be configured to enable wireless communication. For example the transceiver 19 may enable short range wireless communication. In such embodiments the transceiver 19 may be configured to operate in a frequency band according to a radio communication protocol such as Bluetooth (2400-2483.5 MHz), WLAN (2400-2483.5 MHz) or NFC (13.56 MHz). The communication range may be several meters or, in some embodiments of the invention the communication range may be several centimeters.

In some embodiments of the invention the transceiver 19 may also be configured to enable long range wireless communication. For example the transceiver 19 may be configured to operate in a cellular communications network.

In some embodiments of the invention the transceiver 19 may be configured to enable wired communication between the apparatus and another entity. For example, the transceiver 19 may enable a physical connection to be made between the apparatus 1 and another apparatus so that the transfer data 25 may be transmitted via the physical connection.

The controller 4 may be configured to provide information to the transceiver 19 for transmission by the transceiver 19 to another apparatus. The controller 4 may also be configured to decode signals received from external apparatus by the transceiver 19 into information. The received information may be stored in the one or more memories 5.

The at least one memory 5 stores a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIGS. 3A, 3B and 4. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for displaying a plurality of items 53 comprising a first subset of items 55 and a second subset of items 57 wherein the first subset of the plurality of items 55 comprise notifications of events associated with the apparatus 1 and the second subset of the plurality items 57 comprise notifications of events occurring at one or more external servers.

The computer program instructions 11 may provide computer readable program means configured to control the apparatus 1. The program instructions 11 may provide, when loaded into the controller 4; means for displaying, on a display 15, a notification 83 of an event associated with the apparatus 1; and detecting 73 a user input wherein; in response to detection of a first type of user input the notification 83 is added 77 to a list of notifications and in response to detection of a second type of user input the notification 83 is removed 79 from the display 15 and is not added to the list of notifications.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application integration specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

FIG. 3 illustrates a graphical user interface 51 according to an embodiment of the invention. The graphical user interface 51 may be a home page. The home page may be a default graphical user interface which may be provided as an initial graphical user interface whenever a user turns the apparatus 1 on or accesses certain applications of the apparatus. In some embodiments of the invention more than one default graphical user interface may be available to the user of the apparatus 1. In some embodiments of the invention the user input device 17 may provide shortcuts so that a user of the apparatus 1 can quickly and easily access the default graphical user interface 51. In some embodiments of the invention the default graphical user interface 51 may be displayed when the apparatus 1 is in an idle mode of operation.

The graphical user interface 51 may be displayed on the display 15. In the embodiment of the invention illustrated in FIG. 3 the display 15 may be a touch sensitive display 15 which is configured so that a user can make user inputs by actuating the surface of the display 15. The user may actuate the surface of the touch sensitive display 15 by touching the surface of the touch sensitive display 15 with an object such as their finger or a stylus or by bringing an object such as their finger or a stylus into close proximity with the surface of the touch sensitive display 15.

In the graphical user interface 51 illustrated in FIG. 3 a plurality of items 53 is displayed. In the exemplary embodiment illustrated in FIG. 3 the plurality of items 53 are displayed as a list.

The plurality of items 53 comprises a first subset of items 55 and a second subset of items 57. In the illustrated embodiment at least a portion of the first subset of items 55 is displayed on the display 15 simultaneously with at least a portion of the second subset of items 57. The first subset of items 55 and the second subset of items 57 may be displayed in manner which enables a user to easily distinguish between items are within the first subset of items 55 and items which are within the second subset of items 57. For example, in the graphical user interface 51 illustrated in FIG. 3, the first subset of items 55 are displayed in a first area 59 of the display 15 and the second subset of items 57 are displayed in a second area 61 of the display 15. A boundary 63 may also be displayed in the graphical user interface 51 to enable a user to clearly differentiate between the first area 59 and the second area 61.

The number of items available to be viewed may be larger than the number of items which are displayed in the graphical user interface 51 at any one time. A user may be able to control the apparatus 1 to scroll through the items so that different items are displayed. The apparatus 1 may enable a user to scroll through the first subset of items 55 independently of the second subset of items 57. For example, a user may make an input in the first area 59 of the display 15 which changes the items displayed in the first area 59. Similarly the apparatus 1 may enable a user to scroll through the second subset of items 57 independently of the first subset of items 55, for example, by making a user input in the second area 61.

The first subset of items 55 may comprise notifications of events associated with the apparatus 1. In some embodiments of the invention the events associated with the apparatus 1 may comprise events which have occurred at the apparatus 1, for example, they may include a missed incoming call or a message which has been received. In some embodiments of the invention the events associated with the apparatus 1 may comprise events which have been input by a user of the apparatus 1. For example the event may comprise the generation of a reminder regarding information which a user may have stored using a calendar or diary application.

The first subset of items 55 may comprise one or more notifications of events which use a first application of the apparatus 1 and one or more notifications of events which use a second, different application of the apparatus 1. For example, one or more of the notifications may relate to events which use a communication function in which information is transmitted or received using the transceiver 19 and one or more of the notifications may relate to events which use a calendar or diary application.

In the embodiment of the invention illustrated in FIG. 3 the first subset of items 55 comprises three notifications 65A, 65B and 65C displayed which are displayed in the first area 59. The first notification 65A relates to a calendar application. It notifies a user that an appointment which they have scheduled in their calendar will occur shortly. The second notification 65B relates to a missed call. It notifies the user that an incoming call has been received. In the illustrated embodiment the notification 65B also provides information relating to the identity of the incoming caller and the time of incoming call. The third notification 65C relates to a voicemail service. The third notification 65C also provides information relating to the identity of the caller who has left the voicemail and the time at which the voice mail message was created. It is to be appreciated that other notifications may be provided in the plurality of items 53 and that the user may be able to control the apparatus 1 to scroll through the plurality of items.

The user may be able to control the apparatus 1 to update the items in the first subset of items 55. The apparatus 1 may update the items by deleting an item from the first subset of items 55 and/or adding an item to the first subset of items 55. The items in the first subset of items 55 may be updated in response to a user input.

In the exemplary graphical user interface 51 illustrated in FIG. 3 a user selectable item 67 is displayed in the first area 59 with the first subset of items 55. The user selectable item 67 is associated with the function “clear”. In response to user selection of the user selectable item 67 the controller may remove selected items from the first subset of items 55. Once an item has been removed from the first subset of items 55 it is no longer displayed 55 in the default graphical user interface 51.

The second subset of items 57 may comprise notifications of events occurring at one or more external servers. For example, the events may comprise the update of a website or other information which is stored at an external server. The events may relate to services which a user has subscribed to. For example, they may relate to a networking service and the event may be the update of information relating to a contact of the user of the apparatus. In other embodiments of the invention the event may be the update of service such as a news service or information service which the user has subscribed to receive updates from.

In the embodiment of the invention illustrated in FIG. 3 the second subset of items 57 comprises two notifications 69A and 69B displayed in the second area 61. The first notification 69A relates to a news item from a website or service which the user subscribes to. In the particular example illustrated in FIG. 3 the notification 69A provides news information relating to restaurant reviews. The second notification 69B relates to a networking service which the user may subscribe to. The second notification 69B may provide an indication that a contact of the user in the networking service has added or changed content using the service. The notifications 69A and 69B also provide an indication of when the new items were added to the second subset of items 57.

The apparatus 1 may be configured to update the items in the second subset of items 57 automatically without any input from the user. The apparatus 1 may update the items by deleting an item from the second subset of items 57 and/or adding an item to the second subset of items 57.

In some embodiments of the invention the plurality of items 53 may be selectable by a user so that selection of the items enables a user to access a function associated with the item. For example the items may provide shortcuts to the applications of the apparatus 1. This may enable a user to easily return a missed phone call or to access external servers to obtain further information relating to the updated information.

A method of controlling the apparatus 1, according to embodiments of the invention, is illustrated schematically in FIGS. 4A and 4B.

FIG. 4A illustrates a method of updating the first subset of the plurality of items 53.

At block 31 the plurality of items 53 are displayed on the display 15. The plurality of items 53 may be displayed in a graphical user interface 51 as described above in relation to FIG. 3.

At block 33 a user input is detected and at block 35 the first subset of items is updated in response to the detected user input. The first subset of items 55 may be updated 35 by removing an item from the first subset of items 55 or by adding an item to the first subset of items 55 in dependence upon the user input which has been detected at block 33.

In some embodiments of the invention the detected user input may comprise actuation of a user selectable item such as the user selectable item 67 illustrated in FIG. 3. In response to such an input the processor 3 may control the apparatus 1 to delete an item from the first subset of items 55. This may enable a user to delete an item from the first subset of items 55 without causing the apparatus 1 to perform any function in relation to the event indicated by the notification.

In other embodiments of the invention the apparatus 1 may be configured to detect a user input which enables access to a function associated with a notification so that a function in relation to an event indicated by a notification may be performed. For instance, the detected user input may enable a user to make a telephone call, or send a message or delete information from their calendar or diary. The first subset of items 55 may be updated, once the function has been performed, by removing the notification associated with the function which has been performed.

In some embodiments of the invention the first subset of items 55 may be updated by adding an item to the first subset of items 55. In such embodiments of the invention the user input which is detected at block 33 may enable the input of information by the user, for example, the input of information into a diary or calendar application. In other embodiments of the invention the user input which is detected at block 33 may comprise an indication that the user wishes to add a notification to the first subset of items 55. For example, a user may be provided with a notification whenever an event occurs. In response to a user input the notification may be added to the first subset of items. This may be useful for example, if the user does not want to perform a function relating to the notification immediately but would like to easily access the notification again at a later time. An example of a method and graphical user interface which enables a user to add such notifications to the subset of items are described below in relation to FIGS. 5 and 6A to 6C.

At block 37 the updated plurality of items is displayed on the display 15. The updated plurality of items may be displayed when the user access the default graphical user interface 51. In some embodiments of the invention the updated plurality of items may be displayed whenever the first subset of items is updated.

FIG. 3B illustrates a method of updating the second subset of the plurality of items 57 according to an embodiment of the invention.

At block 31 the plurality of items 53 are displayed on the display 15 as described above in relation to FIGS. 3 and 4A.

At block 39 the processor 3 controls the apparatus 1 to automatically check for new items. The check for new items may occur without any user input. The apparatus 1 may check for new items by accessing one or more remote servers. In some embodiments of the invention the apparatus 1 may check for new items by determining whether or not any new messages have been received from one or more external servers. The apparatus 1 may check for messages relating to services to which the user of the apparatus 1 subscribes to.

If the processor 3 determines that there are no new items then the method returns to block 31. The plurality of items is not updated and the previous plurality of items 53 may be displayed on the display 15.

If the processor 3 determines, at block 39, then at block 41 the second subset of items 57 are updated. The second subset of items 57 may be updated by adding the new item to the second subset of items 57.

In some embodiments of the invention the number of items in the second subset of items 57 may be constant so that whenever a new item is added to the second subset of items 57 an old item is removed. In other embodiments of the invention each item in the second subset of items 57 may remain in the second subset of items 57 for a predetermined period of time. The predetermined period of time may be specific to each item. For example an item relating to a news service may remain in the second subset of items 57 for a defined period of time such as twenty four hours whereas an item relating to a score in a sports event may be deleted whenever a new score is available.

In some embodiments of the invention the apparatus 1 may be configured to enable a user to prevent items from being automatically deleted from the second subset of items 57. The apparatus 1 may be configured to enable the user to select one or more items in the second subset of items 57 and designate these as items which are not to be deleted. This may enable the user to ensure that certain items remain in the second subset of items 57, and accessible on the default graphical user interface 51 for as long as is required by the user. This may be beneficial if an item in the second subset of items 57 is of particular interest to the user but they do not wish to act on it immediately. In such circumstances the user may want to ensure that the item remains in the default graphical user interface 51 until they have performed a function or action in relation to the item.

The method illustrated in FIG. 4B may be repeated automatically with no input from the user of the apparatus 1. The method may be repeated at regular predetermined time intervals. The predetermined time intervals may be selected to ensure that the user receives new notifications shortly after the event had occurred.

FIG. 5 schematically illustrates a method of manually adding an item to the first subset of items 55 according to an exemplary embodiment of the invention.

At block 71 a notification 83 is displayed on the display 15. The notification 83 may provide an indication to the user that an event associated with the apparatus 1 has occurred. For example, the notification 83 may notify the user that an incoming call has been received or that a message has been received by the apparatus 1. In other embodiments of the invention the event associated with the apparatus 1 may be the generation of a reminder. For example a reminder may be generated in relation to information which a user has input and stored in the one or more memories 5 of the apparatus 1. Such information may be stored using a calendar or diary application.

The notification 83 may be displayed automatically when the event occurs.

In some embodiments of the invention a plurality of notifications 83 may be displayed simultaneously.

At block 73 the processor detects a user input 73. The user input may be, for example, actuation of a portion of a touch sensitive display 15. Different functions may be performed in response to different user inputs. At block 75 the processor determines whether the detected user input was a first type of user input or a second type of user input. It is to be appreciated that the apparatus 1 may be configured to distinguish between more than two different types of input and that other functions may be performed in response to the detection of a third type of input. For example, in response to a third type of input the apparatus 1 may enable a function associated with the event to be performed.

If the detected user input is determined to be a first type of user input then, at block 77 the notification is added to a list of notifications. The list of notifications may be the first subset of items 55 as described above in relation to FIGS. 3 and 4A and 4B.

The first type of user input may comprise actuation of a user selectable item 85. The user selectable portion 85 may be displayed on the display 15 with the notification 83. It would be appreciated by a person skilled in the art that other types of input may be used in other embodiments of the invention.

If the detected user input is determined to be a second type of user input, then at block 79 the notification is removed from the display 15. The notification 83 is not added to the list of notifications in response to the second type of user input. This enables the notification to be deleted so that the user does not have to view it anymore.

In some embodiments of the invention the second type of user input may comprise a flick input. The flick input may comprise a user making a fast trace input on a touch sensitive display 15. The user may make the trace input by dragging their finger or stylus along the surface of the touch sensitive display 15. The flick input may begin in the area of the display 15 in which the notification 83 is displayed. It would be appreciated by a person skilled in the art that other types of input may be used.

FIGS. 6A to 6C illustrate another graphical user interface 81 according to embodiments of the invention. The graphical user interface 81 may be displayed on a touch sensitive display 15.

The graphical user interface 81 comprises a first area 87 and a second area 89. In the first area 87 information relating to a first application of the apparatus 1 is displayed. For example, in the particular embodiment illustrated in FIG. 6A the user is using the apparatus 1 to access the internet. A list of websites and service which the user may wish to access is displayed in the first area 87.

Notifications 83A, 83B are displayed in the second area 89. In the exemplary graphical user interface 81 illustrated in FIG. 6A to FIG. 6C the notifications 83A and 83B relate to different applications of the apparatus 1 than the application which the user is currently using. In other embodiments of the invention the notifications 83 may relate to the same application that the user is using. It would be appreciated by the person skilled in the art that the notifications 83A, 83B could also be displayed even if the user is not currently using the apparatus 1 to access an application. For example, the apparatus 1 may be in an idle mode.

In the exemplary graphical user interface 81 illustrated in FIG. 6A two notifications 83A, 83B are displayed in the second area 89. The first notification 83A notifies the user that a new voice mail message has been received. The first notification 83A may provide an indication of the identity of the caller who has left the voicemail message. The second notification 83B notifies the user that a message has been received by the apparatus 1. The second notification 83B may provide an indication of the identity of the sender of the message and also some information relating to the content of the message.

In FIG. 6B the user has made a user input by actuating the area of the display 15 in which the second notification 83B is displayed. Two user selectable items 85A and 85B are now displayed on the display 15 with the second notification 83B. In some embodiments of the invention additional information relating to the event may also be displayed in the notification 83B.

The first user selectable item 85A relates to a function associated with the notification. For example, the second notification 83B relates to the event of an incoming message and the first user selectable item 85A relates to the function “reply” and enables a user to control the apparatus 1 to send a message in reply to the received message.

The second user selectable item 85B enables the user to control the apparatus to close the notification 83B such that in response to a user input comprising actuation of the second user selectable item 85B the processor 3 controls the apparatus to remove the notification 83B from the display 15 and add the notification 83B to the first subset of items 55 as described above.

Similarly in FIG. 6C the user has made a user input by actuating the area of the display 15 in which the first notification 83A is displayed so that two user selectable items 85C and 85D are now displayed on the display 15 with the first notification 83A.

The third user selectable item 85C relates to a function associated with the notification. As the first notification 83A is associated with a different application to the second notification 83B the third user selectable item 85C is associated with a different function to the first user selectable item 85A. The first notification 83A relates to the event of received voice mail message and the third user selectable item 85C relates to the function “listen” and enables a user to control the apparatus 1 to play the voice mail message.

The fourth user selectable item 85D is similar to the second user selectable item 85B as it also enables the user to control the apparatus 1 to close the notification 83A such that in response to a user input comprising actuation of the fourth user selectable item 85D the processor 3 controls the apparatus 1 to remove the notification 83A from the display 15 and add the notification 83A to the first subset of items 55 as described above.

When the notifications 83A and 83B have been added to the first subset of items 55 the user may access the first subset of items 55 by accessing the default graphical user interface 51 as described above.

If the user decides that they do not wish to either perform a function in relation to the notification or add the notification to the first subset of items 55 the user may delete the notification. In some embodiments of the invention the user may delete the notification by making a flick input as described above. It is to be appreciated that other types of input may be used. Once the notification has been deleted it is removed from the display and is not added to the first subset of items.

Embodiments of the invention enable the user of an apparatus to control and manage notifications relating to events. The embodiments of the invention provide an easily accessible user interface which enables a user to easily distinguish between notifications of a first type of event and notifications of a second type of event. In the embodiments of the invention the first type of event may comprise events which are associated with the apparatus. Such events may require a response or some action by a user. The second type of events may comprise events which occur at one or more external servers. Such events may be of particular interest to the user of the apparatus but might not require any action or response by the user.

Furthermore embodiments of the invention enable a user to easily control which notifications are added to the user interface. A user may be given the option to add a notification to the user interface when an event occurs. This enables the user to delay responding to the event to a more convenient time. The user interface also acts to provide a reminder to the user of the events and may also provide a shortcut to functions of the apparatus to enable the user to respond to the events.

As the user interface may be a default user interface this makes the list of notifications easy and intuitive for the user to access.

The blocks illustrated in the FIGS. 4A, 4B and 5 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example in some embodiments of the invention the apparatus may be configured to enable a user to copy or move items from one subset of items to the other subset items. This may enable a user to filter out important or particularly interesting items from a subset of items. It may also enable a user to ensure that particular items do not get deleted from the second subset of items.

For example, a user may receive a notification which is automatically added to the second subset of items. The user may wish to perform a function in relation to the notification such as sending the notification to another user or sending a message or making a calendar entry in relation to the notification. For example a notification in the second subset of items may relate to an update on a networking service. The information in the update may prompt the user of the apparatus to perform a function such as messaging the contact from the networking service associated with the item or sending the news to other contacts. The user may be able to move the notification from the second subset of items to the first subset of items by making a particular type of input such as a trace input on a touch sensitive display.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method comprising:
causing display on a display of an apparatus of a plurality of items comprising a first subset of items and a second subset of items wherein the first subset of the plurality of items comprise notifications of events associated with the apparatus and the second subset of the plurality items comprise notifications of events occurring at one or more external servers.

2. A method as claimed in claim 1 further comprising updating the first subset of the plurality of items in response to a user input.

3. A method as claimed in claim 2 wherein updating the first subset of the plurality of items comprises at least one of adding an item to the first subset of the plurality of items or removing an item from the first subset of the plurality of items.

4. (canceled)

5. A method as claimed in claim 3 wherein the user input enables the apparatus to perform a function using an application associated with the item which is removed from the first subset of the plurality of items.

6. A method as claimed in claim 1 wherein the events associated with the apparatus comprise events which occur within the apparatus.

7. A method as claimed in claim 1 wherein the first subset of the plurality of items comprises one or more notifications of events which use a first application of the apparatus and one or more notifications of events which use a second application of the apparatus.

8. (canceled)

9. (canceled)

10. A method as claimed in claim 1 further comprising detecting a user input selecting an item and, in response to the detection of the user input, enabling access to an application associated with the selected item.

11. A method as claimed in claim 1 further comprising automatically updating the items in the second subset of the plurality items wherein the second subset of the plurality items wherein the second subset of the comprises notifications about events associated with a service which the user has subscribed to.

12. (canceled)

13. An apparatus comprising:
at least one processor; and
at least one memory including computer program code;
wherein the at least one memory and the computer program code are configured to, with the at least one processor, enable the apparatus to:
cause display, on a display, of a plurality of items comprising a first subset of items and a second subset of items wherein the first subset of the plurality of items comprise notifications of events associated with the apparatus and the second subset of the plurality items comprise notifications of events occurring at one or more external servers.

14. An apparatus as claimed in claim 13 wherein the at least one memory and the computer program code are configured to, with the at least one processor, enable the apparatus to update the first subset of the plurality of items in response to a user input.

15-24. (canceled)

25. A physical entity embodying a computer program comprising computer program instructions that, when executed by at least one processor, enable an apparatus at least to perform:
causing display on a display of a plurality of items comprising a first subset of items and a second subset of items wherein the first subset of the plurality of items comprise notifications of events associated with the apparatus and the second subset of the plurality items comprise notifications of events occurring at one or more external servers.

26-31. (canceled)

32. A method comprising:
causing display, on a display of an apparatus, of a notification of an event associated with the apparatus; and
detecting a user input wherein;
in response to detection of a first type of user input the notification is added to a list of notifications and in response to detection of a second type of user input the notification is removed from the display and is not added to the list of notifications.

33. A method as claimed in claim 32 further comprising, causing display of one or more user selectable items in relation to the notification.

34. A method as claimed in claim 33 wherein the first type of user input comprises selection of a user selectable item.

35. (canceled)

36. A method as claimed in claim 32 wherein in response to a third type of user input an application associated with the notification is accessed to enable the apparatus to perform a function in relation to the notification.

37. (canceled)

38. (canceled)

39. A method as claimed in claim 32 wherein the list of notifications comprises a plurality of items and the notification is added to a first subset of the plurality of items where the first subset of the plurality of items comprise notifications of events associated with the apparatus.

40. (canceled)

41. An apparatus comprising:
at least one processor; and
at least one memory including computer program code;
wherein the at least one memory and the computer program code are configured to, with the at least one processor, enable the apparatus to:
cause display, on a display, of a notification of an event associated with the apparatus;
detect a user input;
in response to detection of a first type of user input add the notification to a list of notifications; and
in response to detection of a second type of user input remove the notification from the display wherein in response to detection of a second type of user input the notification is not added to the list of notifications.

42. An apparatus as claimed in claim 41 wherein the at least one memory and the computer program code are configured to, with the at least one processor, also enable the apparatus to, cause display of one or more user selectable items in relation to the notification.

43-49. (canceled)

50. A physical entity embodying a computer program comprising computer program instructions that, when executed by at least one processor, enable an apparatus at least to perform:
causing display, on a display, of a notification of an event associated with the apparatus; and
detecting a user input wherein;
in response to detection of a first type of user input the notification is added to a list of notifications and in response to detection of a second type of user input the notification is removed from the display and is not added to the list of notifications.

51-56. (canceled)
